(19) United States
(12) Patent Application Publication
(10) Pub. No.: US 2008/0228996 A1
(43) Pub. Date: Sep. 18, 2008

(54) Portable Data Storage Device Using Multiple Memory Devices

(75) Inventors: Henry Tan, Singapore (SG); Lay Chuan Lim, Singapore (SG); Teng Pin Poo, Singapore (SG)

Correspondence Address: CONLEY ROSE, P.C.;David A. Rose, P. O. BOX 3267, HOUSTON, TX, 77253-3267, US

(73) Assignee: TREK 2000 INTERNATIONAL LTD., Singapore (SG)

(21) Appl. No.: 10/597,331

(22) PCT Filed: Jan. 20, 2004
(86) PCT No.: PCT/SG2004/000020

§ 371 Date: Jul. 20, 2006

(51) Int. Cl. G06F 12/02

(52) U.S. Cl. 711/103; 711/E12.008

(57) ABSTRACT

A portable data storage device includes a USB interface (3), a USB controller (2), a master control unit (7), and two or more NAND flash memory devices (9, 19). The master control unit (7) can send data to the NAND flash memory devices (9, 19) simultaneously through parallel respective 8-bit buses. The master control unit (7) controls the operation of the memory devices (9, 19) by sending them identical control data through respective control signal lines (6, 16). When data is to be stored it is divided into portions which are sent to the respective memory devices (9, 19), and both memory devices are instructed to store data simultaneously. When data is to be retrieved both are instructed to write data back simultaneously to the MCU.

### FIELD OF THE INVENTION

The present invention relates to portable data storage devices, and methods of employing the devices for storing and retrieving data written to them.

### BACKGROUND OF INVENTION

During the past couple of years, there has been much interest in providing a data storage devices containing a flash memory and which can be connected to the serial bus of a computer. A leading document in this field is WO 01/61692, which describes a device subsequently marketed under the trade mark “Thumbdrive”. In one of the embodiments described in this document a male USB plug which is integral with a housing of the device connects directly to a female USB socket in a computer, so that the computer is able to transfer data to and from the flash memory of the portable storage device under the control of a USB controller. Various improvements have been proposed to this device. For example, WO03/003282 discloses that the device may be provided with a fingerprint sensor, and that access to data stored within the device is only allowed in the case that the fingerprint sensor verifies the identity of a user by comparing the user's scanned fingerprint to pre-stored data. The disclosure of both of these documents is incorporated herein by reference.

The structure of such a portable storage device may be as shown in FIG. 1. The portable storage device is within a housing labelled 1. It includes a USB controller 2 which controls a USB interface 3 (i.e. the USB plug) which directly connects to the serial bus 4 (i.e. the USB socket) of a host computer 5. Data transferred to the USB interface 3 from the host computer 5 passes through the USB controller 2 to a master control unit 7. Data packets have sizes which are a multiple of 512 bytes. The master control unit 7 passes these data packets via an 8-bit bus 8 to a NAND flash memory 9. The master control unit 7 controls the NAND flash memory 9 by control signals which are passed by one or more lines show schematically as 6. Typically these lines 6 include a line which carries a “command latch enable” (CLE) signal indicating that a command (such as a WRITE enable signal or a READ enable command) is, or will shortly be, written to the flash memory 9 using the bus 8, a line which carries an address latch enable (ALE) signal which indicates that the bus is presently, or will shortly, transmit to the flash memory 9 via the bus 8 physical address data indicating a location within the memory 9, and a line which send a chip ENABLE signal which has to take a certain value for the flash memory to operate at all. The NAND flash memory 9 is configured to store 512 byte sections of data in respective “windows”, each of which also contains a sector (e.g. of 10 bytes) which stores data verifying the correct storage (i.e. the sector operates rather like a check-bit). When data is transferred out of the device, it passes in 512 byte packets from the NAND flash memory 9, through the 8-bit bus 8, to the master control unit 7. The master control unit 7 sends the 512 byte packets to the USB controller 2, which sends them out of the device 1 through the USB interface 3 to the host 5.

FIG. 2 shows a second possible form of the known memory device. Elements having the same meaning as in FIG. 1 are labelled by the same reference numerals. In contrast to the device of FIG. 1, the device of FIG. 2 includes a second NAND flash memory unit 19 which is connected to the same bus 8. The master control unit controls the second memory 19 using a set of control lines 16. In practice, some of the pins of the master control unit 7 which send control signals may be connected both to one of the lines 6 and to one of the lines 16, so that that pin sends the same control signals to both of the memories 9, 19 at the same time, but at least the chip ENABLE signal is not sent to both of the memories simultaneously. Specifically, when the master control unit is to write data to memory, it enables only one of the memories 9, 19 by sending it the chip ENABLE signal. While the chip enable signal is being sent to that memory, it first sends the CLE signal to the memory via an appropriate one of the lines 6, and simultaneously sends a WRITE enable command (a chip opcode) on the bus 8. Subsequently, while the chip enable signal is still being sent to that memory, it sends an ALE signal via an appropriate one of the lines 6 and simultaneously sends the address data via the bus 8. Then, while the chip ENABLE signal is still being sent to that memory, the master control units uses the bus 8 to send to the memory the data to be stored there. Only the memory 9, 19 which is enabled by the chip ENABLE signal stores the data in the location indicated by the address data, even though both chips receive the data to be stored, and optionally may receive also the CLE and ALE signals.

Similarly, when the memory control unit is to read data, it enables only one of the memories 9, 19 by using the corresponding one of the lines 6 or lines 16 to send it the chip ENABLE signal. While the chip ENABLE signal is being sent, the master control unit uses one of the lines 6 or lines 16 to send that memory the CLE signal and simultaneously uses the bus 8 to send that memory a READ enable command (i.e. a READ opcode) using the bus 8. Subsequently, when the chip ENABLE signal is being sent, the master control unit uses the appropriate one of the lines 6 or lines 16 to send that memory the ALE signal and simultaneously sends that memory the address data using the bus 8. The flash memory 19 in response writes the data to the bus 8.

The term “read instruction” is used in this document to mean data sent by the MCU to a memory device at the same time as a chip ENABLE signal which causes the memory device to transmit data. Thus, as described above, the “read instruction” is first the CLE control signal sent on a control line, and a simultaneous read enable command sent on a bus; and then a ALE control signal sent on a control line and simultaneous address data sent on a bus.

The term “write instruction” is used in this document to mean data sent by the MCU to a memory device at the same time as a chip ENABLE signal which configures the memory device to receive and store data. Thus, as described above, the “write instruction” is first the CLE control signal sent on a control line, and a simultaneously a write enable command sent on a bus; and then the ALE control signal sent on a control line, and simultaneously address data sent on a bus.

The commercialised versions of the devices 1 described above employ the USB1.1 standard, in which the data transfer rate is limited to 15 Mbits/s (i.e. 1.2 Mbytes/s), but the industry is moving to instead use the USB2.0 standard, in which the data transfer rate is 480 Mbits/s (i.e. 40 Mbytes/s). These newer devices use the read/write techniques described above.

### SUMMARY OF THE INVENTION

The present invention aims to provide a new and useful portable data storage device, and in particular one having a higher data transfer rate than the known devices described above.

The present inventors have realised that, when a faster communication standard than USB1.0 is adopted, then the bottleneck for data transfer (i.e. the limit on the bandwidth) may move from the USB interface to other places in the data storage device. In particular, the bottleneck may be the 8-bit bus connection to the NAND flash memory unit.

One way of addressing this problem would be to implement the memory as a 2 chip set, in which data is written simultaneously to two NAND flash memory units through a 16-bit bus. However, this solution is complex.

In general terms, the present invention proposes that the MCU transfers data simultaneously to and from two or more NAND flash memory devices through parallel bus paths, which are enabled to operate at the same time.

In typical embodiments, the one or more (preferably all) pins of the master control unit which send control signals are each coupled to two conductive paths leading respectively to the two memory devices.

This means that each of the memory devices will receive the same amount of data. For example, if there are two memory devices, each will receive half the data which is transmitted for storage.

Specifically, a first expression of the invention proposes a portable data storage device including:
a data interface for transferring data into and out of the device,
an interface controller,
a master control unit, and
at least two NAND flash memory units connected to transfer data to and from the master control unit via respective buses,
the interface controller being arranged to send data received through the interface to the master control unit, and
the master control unit being arranged:
to partition data received from the interface controller into data portions;
to transmit different ones of the data portions to each of the NAND flash memory units simultaneously using the respective data buses; and
to control the NAND flash memory units using control signals which are sent to both the NAND flash memory units, the memory control device transmitting at least chip ENABLE signals to both the NAND flash memory units while transmitting the data portions using the buses.

Preferably all the control signals sent to the NAND flash memory units are identical. Indeed, they are preferably issued by the same pins of the master control unit, with each of those pins being connected to respective control signal inputs of both of the NAND flash memory units.

The interface is preferably a USB interface, more preferably USB2.0 or above. However, the invention is not limited in this respect and the interface may be any other type of interface, such as a Firewire interface (e.g. a Firewire plug).

### BRIEF DESCRIPTION OF THE FIGURES

Preferred features of the invention will now be described, for the sake of illustration only, with reference to the following figures in which:

FIG. 1 shows a first configuration of a known portable data storage device;

FIG. 2 shows a second configuration of a known portable data storage device;

FIG. 3 shows the configuration of a portable data storage device which is an embodiment of the invention; and

FIG. 4 and FIG. 5 are flow diagrams of the operations of the embodiment of FIG. 3.

### DETAILED DESCRIPTION OF THE EMBODIMENTS

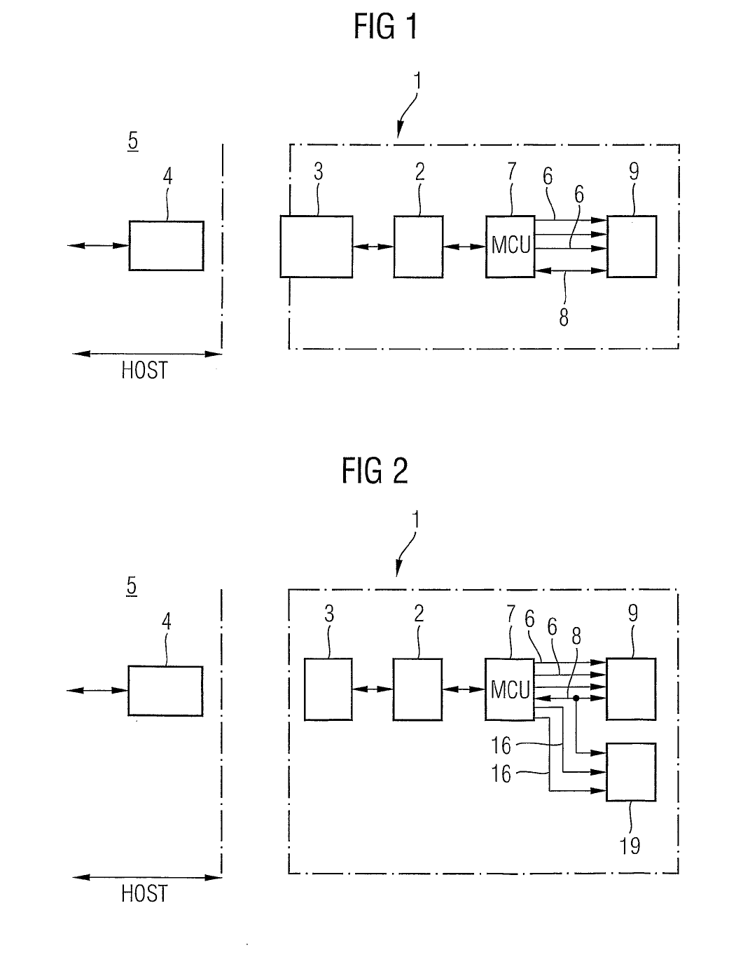

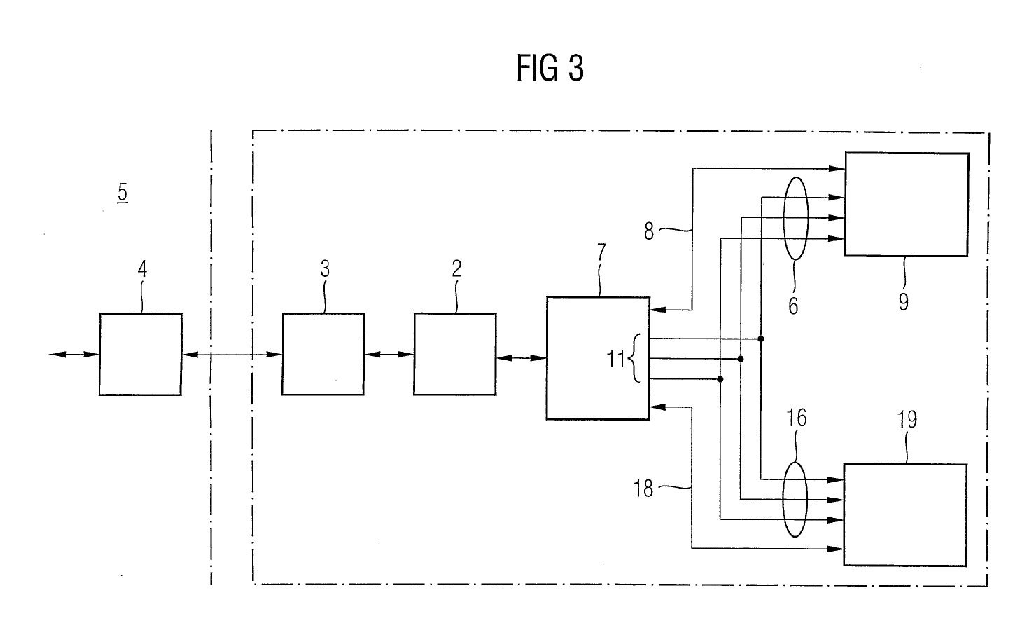

Referring to FIG. 3, the structure of a portable data storage device which is an embodiment of the invention is shown. Elements of the embodiment corresponding to the known devices of FIGS. 1 and 2 are indicated by the same respective reference numerals.

As in the known devices of FIGS. 1 and 2, the data storage device of FIG. 3 includes a housing 1 containing a USB interface 3 for connection to a USB interface 4 of a host computer 5. Typically, the USB interface 3 is a male USB plug directly plugged in to a USB interface 4 which is a USB socket. However, in other possible embodiments a cable may be provided between the interfaces 3, 4. Furthermore, the USB interfaces 3, 4 of the embodiment of FIG. 3 may be replaced by other data interfaces, such as Firewire interfaces.

The USB interface 3 is controlled by a USB controller 2. Preferably, the USB controller 2 and the interfaces 3, 4 operate according to a USB standard with a data transfer rate of at least 480 Mbits/s, such as USB2.0. Preferably, the portable data storage device is powered by power drawn from the host through the interfaces 3, 4.

The USB controller 2 passes data received from the interface 3 to a master control unit (MCU) 7, which is typically implemented by a single integrated circuit package having electrical contacts referred to here as pins. The master control unit (MCU) 7 outputs the data via a 16 output pins. Eight of the output pins are connected to a first 8-bit bus 8, and eight of the output pins are connected to a second 8-bit bus 18. The buses 8, 18 are connected respectively to two 8-bit NAND flash memory devices 9, 19.

The MCU 7 controls the memory devices 9, 19 via control lines 6 connected to control signal input pins of the NAND memory device 9, and control lines 16 connected to the control signal input pins of the NAND memory device 19.

The MCU has a number of pins 11 which emit control signals (such as the ALE control signal, the chip ENABLE control signal, and the CLE control signal) and each of these pins is connected to a respective one of the lines 6 and to a respective one of the lines 16. Thus, the MCU transmits the same control signals simultaneously to the two memories 9, 19.

The USB controller 2 typically passes any data received through the interface 3 to the MCU 7 in packets of size 512 bytes. The MCU 7 divides this data into data packet portions of size 256 bytes. To begin with, the control signal pins 11 of the MCU 7 transmit simultaneously the CLE and chip ENABLE control signals to both of the memories, and simultaneously uses both the buses 8, 18 to send the WRITE enable commands (i.e. the WRITE opcode) to both the memories 9, 19. Subsequently, the MCU 7 transmits the chip ENABLE control signal and the ALE control signal to the two memories 9, 19 simultaneously, and (normally at the same time) transmits to the two memories 9, 19 using the buses 8, 18 the respective physical addresses in the memories 9, 19 to which the data should be written. Following that, and while the MCU 7 is still sending the chip ENABLE control signal to both memories 9, 19, the MCU 7 uses the buses 8, 18 to transmit the data packet portions which are to be written to that address in the respective memories 9, 91.

Preferably, each word in the packet the MCU 7 receives from the USB controller 2 is split into two bytes, which are then simultaneously transmitted to the two respective memory devices 9, 19 via the respective buses 8, 18. The two bytes are preferably stored in the respective memory devices 9, 19 at corresponding addresses. This occurs because both of the memory devices are preferably sent the same address data from the MCU 7 via the buses 8, 18 at a time when the ALE signal has configured the memories 9, 19 to recognise that address data. Note however that the physical addresses may be different, e.g. such that they are part of the same “row” of the memories (in flash terminology a “row” (or “block”) is a set of “pages”, such that in conventional flash devices all the pages of a given row have to be erased together; thus, a physical address in the memory is conventionally encoded as a number indicating a row, followed by an number indicating the “offset”, i.e. a particular one of the pages within that row) but at the same “offset” location within the rows. This scheme has the advantage of simplicity. However, in other embodiments, the 512 bytes may be divided in other ways.

When it is desired to extract data from the portable storage device (e.g. in response to a control signal input into the portable storage device through the interface 3), the MCU 7 uses the appropriate one of the control signal lines 6 and the appropriate one of the control signal lines 16 to send the chip ENABLE control signals to both the memories, simultaneously uses the appropriate one of the control signal lines 6 and the appropriate one of the control signal lines 16 to send the CLE control signals to both the memories, and simultaneously uses the bus 8 to send the READ enable command (i.e. READ opcode) to both the two memories. Subsequently, and while the chip ENABLE code is still being sent to the two memories, the MCU 7 uses the appropriate one of the control signal lines 6 and the appropriate one of the control signal lines 16 to send the ALE control signal to both the memories 9, 19, and simultaneously uses the bus 8 to send address data to both the two memories. In response, and while still receiving the chip ENABLE control signals, the memories 9, 19 transmit the corresponding data to the corresponding bus 8, 18. Thus, the MCU receives 16 bits of data at each clock cycle. It transmits this data via the USB controller 2 to the USB interface 3, which transmits it on to the interface 4.

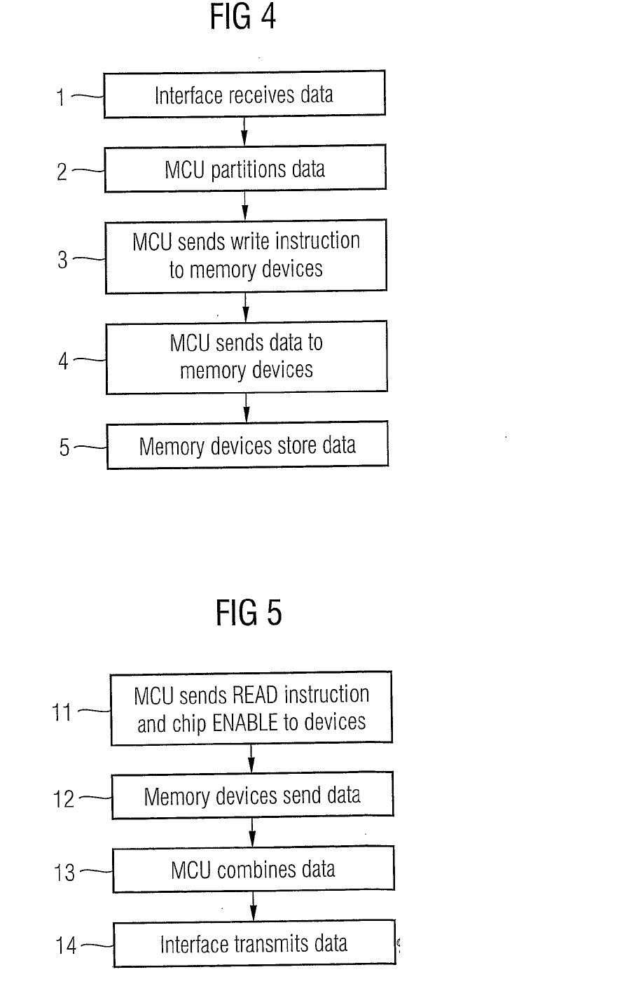

The process for storing data in the device of FIG. 3 is shown in FIG. 4. In step 1, the interfaces 3, 4 receive a data packet, which is transmitted from them to the interface controller, and then to the master control unit 7. In step 2, the master control unit 7 partitions the data packets received from the interface controller word-by-word, into data packet portions which each contain a single byte of data to be stored. In step 3 the master control unit 7 transmits the chip ENABLE control signal and simultaneously a WRITE instruction (i.e. firstly the CLE control signal and simultaneously the write enable command; then the ALE control signal and simultaneously the address data) to both the memory devices 9, 19. In step 4, while the chip ENABLE control signal is still being sent, it transmits different ones of the data packet portions simultaneously to each of the NAND flash memory units 9, 19 simultaneously through different respective buses 8, 18, and in step 5 the respective flash memory units 9, 19 store the data packet portions.

The process of retrieving data from the portable data storage device of FIG. 3 is shown in FIG. 5. In step 11 the master control unit 7 (in response to an instruction received from outside the device) transmits the chip ENABLE control signal and simultaneously a read instruction (i.e. firstly the CLE control signal and simultaneously the read enable command; then the ALE control signal and simultaneously the address data) simultaneously to the flash memory units 9, 19. In step 12, while the chip ENABLE control signal is still being sent, the flash memory units in response to the read instructions transmit simultaneously the data to the master control unit 7 through the respective buses 8, 18. In step 13 the master control unit 7 combines the respective bytes of data received from the flash memory units 9, 19 into words which are formed into data packets and transmits the data packets to the interface controller 2. In step 14, the interface controller sends the data packets through the interface 3 out of the device.

Note that step 3 and step 11 are each performed by the following 6 sub-steps:
a) Enable both memory chips 9, 19 (both memory chips are kept enabled through out the writing).
b) send both chips the command latch enable command (a control signal)
c) send the command opcode though the data bus 8, and the opcode will be interpreted by the memory chips 9, 19 as a command.
d) Disable command latch enable to both chips.
e) Enable the address latch enable command (a control signal)
f) send the address opcode through data bus, and the opcode will be interpreted by the memory chips 9, 19 as an address
g) Disable the address latch enable command.

It should be understood that the processes of FIGS. 4 and 5 are generally performed on the fly, on a word-by-word basis. In other words, FIGS. 4 and 5 show the processing of a single word. Thus, for example, while the device is performing step 2 in respect of a certain word, the interface 3 may be performing step 1 in respect of a subsequent word.

Alternatively, although less preferably, in other embodiments of the invention steps of FIGS. 4 and 5 may be performed in respect of complete data packets. Thus, in the case of FIG. 4, a complete data packet may be received by in the MCU and stored in a data cache, before the MCU begins to partition it, and send the portions to the memory devices 9, 19.

We have determined that the embodiment can write data to the memory at a rate of 15 Mbytes/s, and to read data at the rate of 20 Mbytes/s. This is both simpler and faster than an alternative arrangement in which the MCU writes data alternately to two memory devices.

Note that the above description may in practice be complicated by the requirements of NAND flash memory devices. For example, as mentioned above, the windows of a conventional NAND flash memory device can be thought of as a two dimensional array of windows, and only entire rows of the memory can be erased at once. Thus, when, in the known device of FIGS. 1 and 2 it is desired to erase some but not all of the boxes in a row (to free them for other data to be written to them) of memory device 9, the MCU 7 must take action to ensure that the data in the boxes which are not to be erased is preserved. There are several strategies for this. One possibility is for the MCU 7 to instruct the memory device 9 to write the data to which is to be preserved to be copied to the bus 8, and for the MCU 7 to store it in a cache. Then the row of the memory device 9 can be erased, and the data written back from the cache to the memory device. Another possibility if for the MCU 7 to instruct the memory device 9 to copy the data from the row which is to be erased to another row of the memory device 9.

Both of these possibilities have analogues in the embodiment of FIG. 3 also. In particular, the MCU 7 will typically be arranged to erase respective complete rows of both the memory devices 9,19 simultaneously, and will be arranged to communicate with the memory devices 9, 19 to ensure that any data in those rows which is not to be deleted is stored elsewhere before the deletion occurs. Since, as mentioned above, preferably each individual byte received by the MCU 7 from the USB controller 9 is divided between the two memory devices 9, 19 and the two portions are stored in corresponding memory addresses in the two memory devices 9, 19, it will generally be the case that the data in the respective rows of the respective devices which is to be preserved will be in identical positions within the rows of the respective memory devices 9, 19. Thus, the MCU may preserve the data by sending identical control signals to the two memory devices 9, 19.

A first possibility is for those control signals to instruct the memory devices 9, 19 to transfer any data in those rows which is not to be erased to the buses 8, 18, so that the MCU 7 can receive this data and store it within a RAM (e.g. an internal RAM of the MCU 7 which acts as a data cache). Then, it may send the control signals necessary to the memory devices 9, 19 for the respective rows to be erased. Then, it may transmit the data back from the RAM simultaneously to the memory devices 9, 19 via the respective data buses 8, 18, to be re-written into the memory devices 9, 19. The MCU 7 sends ALE signals through the lines 6, 16 and addresses through the buses 8, 18 to indicate the location in the memory devices 9, 19 where the data should be stored (possibly at a different memory location from that at which it was originally stored).

Alternatively (i.e. in alternative embodiments of the invention, or in different modes of operation of the same embodiment), the MCU may preserve some data in a row which is to be erased by using the lines 6, 16 to send identical instructions to the memory devices 9, 19 to copy (or move) that data to other rows. When this has been done, the MCU uses the lines 6, 16 to send an identical instruction to each of the memory devices 9, 19 which causes them to erase the data.

Although only a single embodiment of the invention has been disclosed here, many variations are possible within the scope of the invention as will be clear to a skilled reader. For example, the number of NAND flash memory devices is not limited to two, and may be any higher number. Furthermore, although it is preferred that the USB standard employed by the USB controller is version USB2.0, the present invention may be implemented with any versions of the USB standard which are introduced in the future.

Also it should be noted that embodiments of the invention may have many features which are not shown explicitly here, but which are known in other publicly-available portable data storage devices, such as password protection, access controlled by biometric verification, such as fingerprint verification, etc. The implementation of such features will be clear to one skilled in the art.

1. A portable data storage device including:
a data interface for transferring data into and out of the device,
an interface controller,
a master control unit, and
at least two NAND flash memory units connected to transfer data to and from the master control unit via respective buses,
the interface controller being arranged to send data received through the interface to the master control unit, and
the master control unit being arranged:
to partition data packets received from the interface controller into data packet portions;
to transmit different ones of the data portions to each of the NAND flash memory units simultaneously using the respective data buses; and
to control the NAND flash memory units using control signals which are sent to both the NAND flash memory units, the master control unit transmitting at least chip ENABLE signals to both the NAND flash memory units while transmitting the data portions using the buses,
wherein the master control unit is further arranged to transmit a signal simultaneously to the at least two NAND flash memory units which causes the erasure of a section of the memory space of each of the at least two NAND flash memory units.

2. A device according to claim 1 in which the NAND flash memory units are arranged to transmit simultaneously to the master control unit data packet portions, the master control unit being arranged to combine them to form data packets, and transmit the data packets to the interface controller for transmission through the interface controller.

3. A device according to claim 1 in which there are two NAND flash memory units, and the master control unit is arranged to divide the data packets into data packet portions such that each word of the data to be stored is divided into two bytes which are included in data packet portions for different ones of the NAND flash memory units.

4. A device according to claim 1 in which the master control units sends identical control signals simultaneously to both the NAND flash memory units through pins of the master control unit which are each electrically connected to a control signal line, each control signal line leading to respective control signal inputs of the each of the NAND flash memory units.

5. A device according to claim 4 in which the master control unit transmits identical WRITE, READ, ENABLE and ALE signals to the respective memory devices.

6. A device according to claim 1 in which the interface is a USB interface, and the interface controller is a USB controller.

7. A device according to claim 6 in which the interface operates according to a USB standard in having a data transfer rate of at least 480 Mbits/s.

8. A device according to claim 1 in which the respective parallel data buses are 8-bit buses.

9. A device according to claim 1 in which each of the data packet has a predetermined size of 512 bytes.

10. A device according to claim 1 in which the master control unit is operative, before transmitting the signal to each of the NAND flash memory units which causes them to erase a section of their respective memory spaces, to instruct each NAND flash memory unit to transfer a portion of the data stored in that section of the memory space to a different location.

11. A device according to claim 10 in which the different location is in a RAM memory.

12. A device according to claim 10 in which the different location is in a location in the respective memory spaces outside the section which is to be erased.

13. A method of storing data in a portable data storage device including a data interface for transferring data into and out of the device, an interface controller, a master control unit having a cache memory, and at least two NAND flash memory units, the method including the steps of:
the interface controller sending data packets received through the interface to the master control unit,
the master control unit partitioning the data packets received from the interface controller into data packet portions, and transmitting different ones of the data packet portions simultaneously to each of the NAND flash memory units simultaneously through different respective buses, and controlling the NAND flash memory units using control signals which are sent to both the NAND flash memory units, the master control unit transmitting WRITE instructions and chip ENABLE control signals to both the NAND flash memory units, and subsequently, while still sending the chip ENABLE control signals, transmitting the data packet portions to the respective NAND flash memory units using the respective buses,
the respective flash memory units storing the data packet portions,
wherein the method further includes the step of the master control unit transmitting a signal simultaneously to the at least two NAND flash memory units which causes the erasure of a section of the memory space of each of the at least two NAND flash memory units.

14. A method of claim 13 and further being a method of retrieving data from a portable data storage device, the method including the steps of:
the master control unit issuing simultaneously to the flash memory units respective READ instructions and chip ENABLE signals;
the flash memory units in response to the READ instructions, and while still receiving the chip ENABLE control signals, transmitting simultaneously the data to the master control unit through different respective buses;
the master control unit combining the data received from the flash memory units for form data packets and transmitting the data packets to the interface controller; and
the interface controller sending data packets received from the master control unit out of the device through the data interface.
